(19) United States
(12) Patent Application Publication
(10) Pub. No.: US 2026/0362111 A1
(43) Pub. Date: Nov. 12, 2026

(54) MULTIPURPOSE COMMUNICATIONS DEVICE

(71) Applicants: Matthew Chentnik, Crawfordville, FL (US); Thomas Chentnik, Roanoke, TX (US)

(72) Inventors: Matthew Chentnik, Crawfordville, FL (US); Thomas Chentnik, Roanoke, TX (US)

(21) Appl. No.: 19/667,891

(22) Filed: May 5, 2026

Related U.S. Application Data
(60) Provisional application No. 63/800,573, filed on May 6, 2025.

(51) Int. Cl. H04W 4/90; H01Q 1/12; H01Q 1/24; H04B 7/24; H04R 27/00

(52) U.S. Cl. CPC H04W 4/90; H04B 7/24; H04R 27/00; H01Q 1/1228; H01Q 1/246

(57) ABSTRACT

A beach mounted multipurpose communications device that serves as a communications tower for a system to transmit and receive public and private network communications while integrating cameras, a digital marquee, signal lights, audible alerting devices, a speaker, and sensors to monitor ocean surf conditions including wave height, wind speed, and water temperature. The system collects and transmits surf data to mobile devices, websites, or displays, providing valuable information for surfers, lifeguards, and coastal visitors. The multipurpose communications device incorporates environmentally friendly design elements, including solar power, to ensure sustainability and aesthetic integration into beach environments. The system can be remotely controlled such that the marquee, alert lighting, siren, and speakers can be managed from a distant location. The entire concept can be used in any environment needing a multipurpose communications device such as this. It is not limited to deployment on public beaches.

### PRIORITY CLAIM

In accordance with 37 C.F.R. 1.76, a claim of priority is included in an Application Data Sheet filed concurrently herewith. This application claims the priority to U.S. Provisional Patent Application No. 63/800,573 entitled “MULTIPURPOSE COMMUNICATIONS DEVICE”, filed May 6, 2025, the contents of which is incorporated herein by reference in its entirety.

### FIELD OF THE INVENTION

The present invention relates to public safety and, more particularly, to a multipurpose communications device for placement on coastal beaches, and additionally, roadways and other public areas.

### BACKGROUND OF THE INVENTION

Surf conditions are commonly reported to the public by the use of warning flags placed on beach mounted flagpoles. Warning flags must be manually raised or lowered and use colored flags that are only visible during the day. The flagpoles are mounted in the sand near the water where they can be readily seen by the public. Flags follow an international standard of colors and quantities to indicate various hazardous surf conditions, such as high rip currents or dangerous marine life. Flags that are not visible at night fail to alert beachgoers against any hazardous conditions and, even if seen, fail to provide timely information regarding changes in surf conditions. Moreover, there is no known means of monitoring the status of the flagpoles from a remote location. As the global population increases and the number of beachgoers increases, this puts the public and public safety entities at unnecessary risk.

With these very limited and antiquated systems, flagpoles, public awareness is limited, public safety is diminished, liability is increased, and, unfortunately, injuries and deaths have increased, primarily from drowning due to rip currents and high surf conditions. From a public safety perspective, there is a need to provide earlier detection of changes in surf conditions and to provide better communications regarding condition changes or unsafe conditions.

The problem this invention solves is the replacement of antiquated, manually controlled public safety devices with a combination of modern technology in a multipurpose structure that can greatly benefit public safety in numerous ways. Beach surf condition communications devices are one of the primary intents for this invention.

First responders rely on wireless voice and data communications for more and more of their job functions. Technology and modern, reliable communications are crucial to their day to day operational success. Currently, mobile phone and internet services are limited on public beaches, especially highly trafficked ones. As the number of beachgoers increases, so does the demand for wireless communications. The coverage and capacity demands on highly frequented public beaches are a challenge for all forms of wireless communications, be they licensed or unlicensed.

Therefore, an electronic multipurpose communications device, so to speak, could provide all necessary public safety functions with highly visible LED lights (or any other type of light) and additionally be used for voice and data traffic from Wi Fi, cellular, public safety radio systems, or low earth orbit satellite communications or a combination of any or all. This would allow the necessary data connection on the pole itself that would be required for remote control of the lights, signage, or electronic features. If replacing a non electrically powered communications device with a new one with electrical power, it may also have warning lights instead of flags, wireless antennas, fiber or mesh network connections, signage, cameras, public address equipment, and any other modern technology that applies to this upgrade. The communications devices now are very limited in what they can do. With power, modern design and modern technologies applied, these poles become far more capable, multipurpose structures that can do a wide range of services simply not possible with the old communications devices.

The opportunity to replace these old communications devices with a more modern, more capable combination of technologies in a multipurpose design exists. The challenges of building infrastructure that can survive very harsh conditions on the coastline and still be aesthetically pleasing and acceptable to the general public must be addressed. A replacement of existing communications devices with more modern but still unobtrusive variants, such as those described in this disclosure, can become commonplace and blend seamlessly with the surroundings.

### SUMMARY OF THE INVENTION

The present invention provides an intelligent, multipurpose communications system that performs three primary functions: (1) monitoring environmental conditions, (2) communicating with individuals in the vicinity, and (3) transmitting and receiving data for essential public service operations. The system employs a plurality of sensors and manual input devices to collect a wide range of environmental data, including ocean surf conditions, weather metrics, solar irradiance, wind speed and direction, barometric pressure, audio and high definition video, and optionally, radar and LIDAR inputs.

Communication with beachgoers and local personnel is facilitated via multiple outputs, such as a digital marquee for visual displays, integrated speakers for audible alerts, and voice messaging, and color coded lighting systems for real time condition alerts. These communications can be controlled locally or remotely, and may include preprogrammed or real time updates.

Mounted on a vertical support, displacing the conventional flagpole, the system transmits and receives data via a central system controller. This controller communicates with each sensor and device using standard protocols, and is capable of both scheduled and on demand operations. Data and control signals may be exchanged over cellular networks, public Wi Fi, public safety radio frequencies, low Earth orbit (LEO) satellite links, or wired LAN infrastructure. The controller may be configured to automatically perform routine tasks—such as periodic data uploads and system diagnostics or respond to ad hoc commands issued remotely or locally.

Power for all components is provided by a shared power supply architecture that may include: a grid connected electrical supply, solar panels with power inverters, and a battery based energy storage system. A battery is included in all embodiments to ensure continued operation during power interruptions. The system controller manages power source selection and preferences, and power availability.

The system's various communications and display devices are operated according to instructions received from the system controller. These may be triggered remotely, locally, or via scheduled programming. Examples of such control include altering visual displays, adjusting audio output, changing lighting states, and rebooting or disabling specific devices.

In addition to environmental sensing and communication, the system includes self monitoring capabilities. The system controller continuously tracks the operational status of each connected device or sensor. If a device malfunctions or becomes non responsive, the controller logs the issue and can transmit diagnostic data to a designated recipient.

The invention significantly improves upon the prior art by enabling automation, remote control, real time monitoring, and scheduled management of public safety and data collection activities—functions that are currently performed manually.

An objective of the invention is to provide an enhanced beach mounted multipurpose communications device system mounted on a vertical support, capable of monitoring environmental conditions, communicating with the public, and facilitating essential data transactions for public safety.

Another objective is to replace legacy beach communications devices with a modern, multipurpose electronic communication platform. This includes remote controlled lights, displays, sensors, cameras, and networking capabilities for real time hazard alerts and environmental monitoring.

An additional objective is to provide a scalable communications infrastructure that allows centralized control and aggregation of data from a network of such communications devices, offering 24/7 remote access for improved coordination with first responders and emergency services. Traffic patterns, AI statistics, and data collection can be acquired as well.

Further objectives include real time determination and display of surf hazard levels, detection, and alerting of dangerous marine life, and dissemination of relevant safety information.

A related objective is to extend the invention's functionality to other public safety and information applications, such as pedestrian crosswalks, traffic control, school zones, severe weather alerts, and general public address systems.

The advantage of this invention lies in its integration of existing, proven technologies into a unified, cost effective, and remotely managed public safety platform. This system enhances communication, improves environmental monitoring, and supports both public and private communication networks with minimal maintenance requirements.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE DRAWINGS

FIG. 1 is a side view of the multipurpose communications device communications/cell phone tower;

FIG. 2A depicts a side view of a mounting using a reinforced helical pad;

FIG. 2B depicts a side view of a mounting using a helical pier;

FIG. 2C depicts a side view of a mounting using a ballast;

FIG. 3 is a flow diagram showing how data moves from device to device within the invention; and

FIG. 4 is a flow diagram showing how power moves throughout the invention.

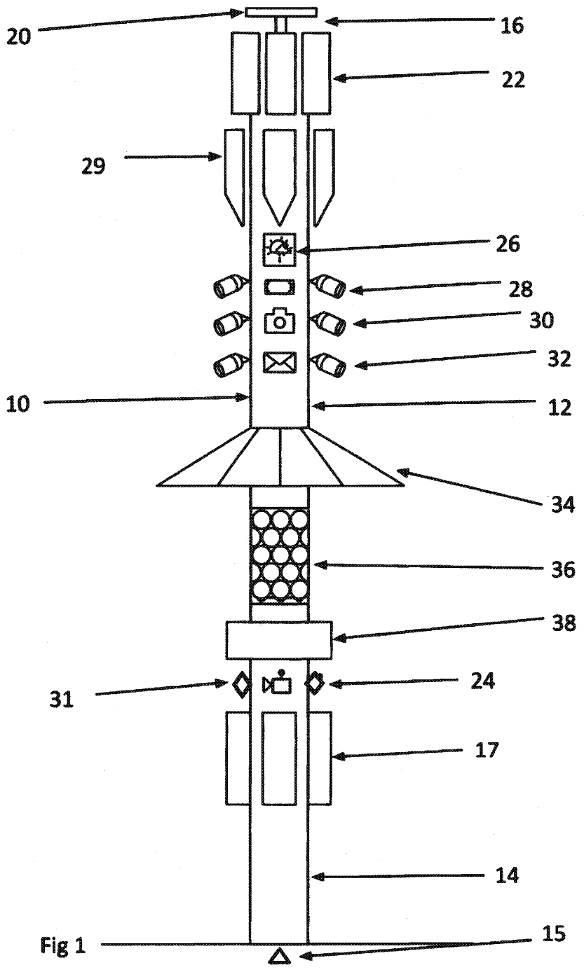

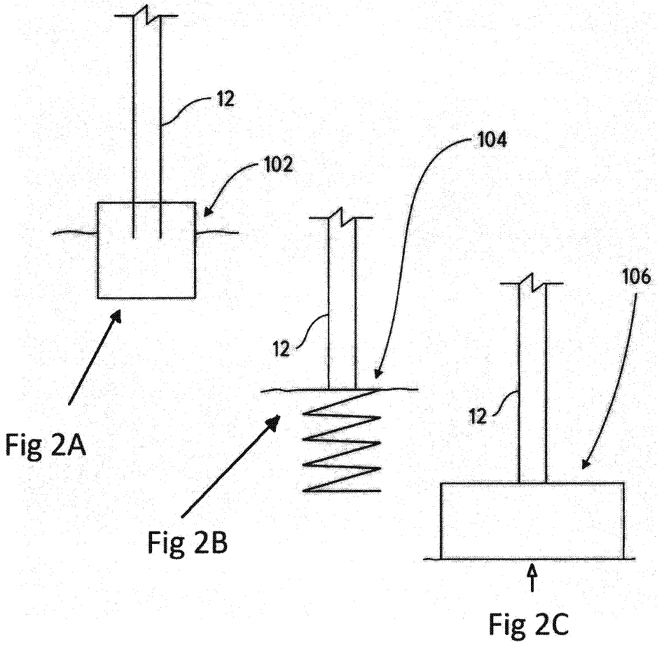

### DETAILED DESCRIPTION OF THE INVENTION

The present invention relates to poles installed in public spaces and how they can be combined with other technologies to produce a multiple purpose pole primarily used for public safety. More particularly, it will replace and modernize existing coastal beach communications devices with a multipurpose electronic communications site, combined with remote controlled lights, signage, cameras, and sensors to be used for surf condition data collection and warning systems on heavily visited public beaches worldwide. A replacement of the old beach warning system communications devices with modern, multipurpose warning lights and communications infrastructure that enable centralized control and aggregation of data collected through these systems. It will allow these public safety communications devices to become usable and updatable remotely 24/7 and more precisely managed in real time to allow for enhanced public safety and critical communications for first responders. This would include, but would not be limited to surf condition hazard levels, alerts to the presence of hazardous marine life, etc. These modernized, wirelessly controllable public safety sign concepts would not be limited to replacing beach communications devices. They could be used worldwide for numerous multipurpose information and public safety systems such as crosswalks, traffic control, school crossings, public address systems, tornado and severe weather warning networks, and the like.

Now referring to the Figures, the communications tower 10 resembles a standard communications device to blend into beach or coastal environments. A support pole 12 has a base 14 constructed and arranged for anchoring to a coastal beach front leaving a top end 16 vertically disposed between 30 and 40 feet above the beach front. The support pole can be made of basalt, PVC fiberglass, steel, aluminum, composite or any other material that can withstand the elements and extreme weather events having diameter between 10 and 12 inches. The support pole 12 is anchored to the ground using a reinforced concrete pad 102, helical piers 104, or with ballast 106 placed above ground, below ground, or both.

The support pole 12 is constructed as a hollow structure, forming an internal chamber that serves as a conduit for housing various electrical and communications infrastructure. This chamber accommodates wiring, fiber optic cables, power conductors, battery cells. Optional knockouts strategically positioned along the length of the pole enable modular attachment of external accessories or devices, such as lighting fixtures, cameras, antennas, sensors, or other electronic modules. The lower end of the pole 12 interfaces with a base structure 14, through which multiple types of cabling and power lines may enter the pole, including but not limited to commercial AC power 15, low voltage DC power, fiber optic lines, coaxial cable, and Ethernet/network cabling.

In one embodiment, the communications tower 10 is designed to integrate with a commercial power grid. A built in power management system within the pole or its base is configured to regulate, condition, and distribute electrical power appropriately to all connected or embedded electronic components. This ensures safe and stable operation even during fluctuations in voltage or transient disturbances. The system may include surge protection, voltage regulators, and intelligent switching mechanisms.

Additionally, the device may feature user accessible power outlets or USB charging ports integrated into the pole or an associated enclosure, allowing individuals to charge personal electronic devices such as mobile phones, tablets, or laptops in public or remote settings.

To maintain continuous operation of critical components such as communication relays, lighting, sensors, or emergency signaling devices—a battery system enclosure 17 is included within or adjacent to the pole structure. This enclosure houses rechargeable battery packs that automatically engage to provide backup power during periods of low voltage or temporary power loss, thereby ensuring operational reliability and service continuity. A satellite 20 is positioned at the top end 16 of the support pole 12 for a low earth or mid earth orbit satellite ISP antenna. If no internet or cellular connection is available as satellite system. For instance, the Starlink mini has the ability to provide internet access in remote areas where traditional ISPs cannot reach.

An alert lighting system 22 is positioned beneath the satellite and provides a means of alerting people to hazardous conditions. In an embodiment, the warning lighting system is multicolor, remote controllable single or multi sector LEDs.

A telecommunication module 24 coupled to the support pole 12 includes a system controller or multiple controllers to manage the various installed electronic devices. The module supports the satellite and may include a cellular antenna configured to provide wireless communication coverage. The telecommunication module including a communication interface configured to support operation of multiple public and private, licensed and/or unlicensed wireless communication systems from different carriers and/or government entities, and the satellite antenna 20. Cellular 29 can be a single or multi sector, multi carrier, or multi band, including public safety radio communications.

A weather station 26 having LIDAR based sensors or radar includes a real time surf condition monitoring system for surfers, lifeguards, swimmers and coastal management. The weather station is interfaced with a telecommunication module coupled to a wave height camera, a wind speed and direction sensor, and a barometric pressure sensor, and water temperature sensor provides real time information. A receiver 31 coupled to the weather station is configured to receive sensory data transmitted from offshore sensors such as those remotely linked to a buoy system.

Photocell controlled area lighting 28 provides lighting for the area surrounding the pole 12 areas during low lit times. LED or high intensity discharge (HID) lights are used for the pole perimeters or other large areas. The system includes a photocell sensor mounted in an exposed location on the pole, which automatically detects ambient light levels. When the surrounding natural light drops below a predetermined threshold, the photocell activates the lighting system, thereby energizing the connected lighting fixtures.

A high definition video camera 30 is mounted in an elevated position on the pole 12 and is configured for pan, tilt, and rotational movement to enable comprehensive visual monitoring of the surrounding environment. The camera may be controlled remotely or through automated routines, allowing an operator or control system to dynamically adjust its field of view based on environmental conditions or detected activity. The camera 30 is specifically configured and positioned to survey the surf zone and is capable of identifying distressed humans or animals in the water, allowing for rapid response by lifeguards or emergency personnel. The high definition imaging capabilities provide detailed, real time visual data that can be used for both live monitoring and recorded review. The camera's field of view includes the adjacent beach area, thereby offering extended surveillance coverage for crowd management, lost persons, or other public safety concerns occurring on land.

Complementing the video surveillance system are one or more speakers 32, forming a public address (PA) audio system that enables real time communication with individuals on the beach or in the water. The speakers may be used to issue safety warnings, evacuation instructions, or general announcements related to beach conditions, marine life hazards, weather alerts, or other relevant public safety information. The audio system can be activated manually by authorized personnel or automatically in response to specific detected conditions. The camera and speaker system form an integrated surveillance and public communication platform, enhancing situational awareness and enabling timely interventions to protect public health and safety.

The device may have solar power generation capability installed. In which case, the power management system will also include a DC/AC inverter to manage the DC power produced by the solar system and to make it usable by the electronics on the device. In one embodiment, a photovoltaic power generation ring 34 is operatively coupled to the exterior surface of the tower structure. The ring is configured in a conical or frustoconical shape, with its wider base oriented outward and downward to maximize exposure to incident sunlight throughout the day. This geometric configuration allows the surface of the ring to intercept direct sunlight across varying angles, enabling efficient solar energy collection from sunrise to sunset without the need for complex mechanical tracking systems.

The conical orientation ensures that at any given time during daylight hours, at least a portion of the photovoltaic surface area is optimally aligned with the sun's rays. As the sun moves across the sky, different sections of the ring sequentially receive peak solar irradiance, resulting in consistent power generation throughout the day. This passive tracking functionality reduces system complexity, minimizes maintenance requirements, and improves reliability compared to conventional solar tracking assemblies.

The photovoltaic ring 34 may comprise monocrystalline or polycrystalline solar cells, encapsulated within weather resistant, transparent coatings to withstand harsh environmental conditions such as salt spray, UV exposure, and wind loading, particularly in coastal or marine environments. The electrical output of the photovoltaic system may be used to power various integrated components of the tower, including the high definition surveillance camera 30, public address speakers 32, area lighting system 28, and other electronic subsystems. Excess energy, if any, may be stored in onboard battery modules or directed into a local microgrid for auxiliary usage. This configuration not only promotes sustainable and autonomous operation of the tower system but also contributes to environmental resilience and off grid capability in remote or disaster prone areas.

Beneath the ring 34 is a thin film of solar cells 36 that is applied directly to the support pole 12. The thin film of solar cells generates electrical power by converting sunlight into electricity through the photovoltaic (PV) effect, just like traditional solar panels—but with enhanced flexibility and form factor. The thin film may consist of amorphous silicon or cadmium telluride solar cell materials deposited onto a flexible substrate. This enables the PV layer to conform to the curvature of the pole, forming a continuous or segmented cylindrical solar array.

To further enhance public utility and safety, a remote controllable digital sign or marquee 28 is affixed to or integrated with the support pole 12, preferably at a height and orientation that ensures high visibility to individuals in the immediate vicinity of the multipurpose communications device 10. The digital sign 28 is constructed using a high brightness LED display, enabling clear legibility in a wide range of lighting conditions, including full sunlight and nighttime environments.

The digital sign 38 is configured to display real time information and alerts that are relevant to public safety, environmental awareness, or general informational needs. The sign may be controlled via the remote wireless connection allowing authorized personnel or automated systems to update the displayed content dynamically and in real time from a centralized or mobile command center. The content displayed may include, but is not limited to: weather alerts, including approaching storms, lightning activity, rip current advisories, or extreme heat warnings; emergency events, such as shark sightings, missing persons, or evacuation orders; public health and safety messages, including air quality alerts, jellyfish blooms, or water contamination warnings; informational announcements, such as beach rules, flag conditions, event notices, or lost and found information. This system is particularly advantageous for beach visitors who may be distracted or otherwise unaware of changing conditions, as it provides visual alerts in close proximity to high traffic areas such as entry points, lifeguard stations, restrooms, or concession stands.

The integration of the digital sign 28 with the entire multipurpose communications device 10 allows for synchronized messaging across multiple platforms, including audible alerts through the public address system and visual cues through the signage. This dual mode communication strategy ensures maximum reach and comprehension, especially in noisy or crowded environments where one form of alert may be missed.

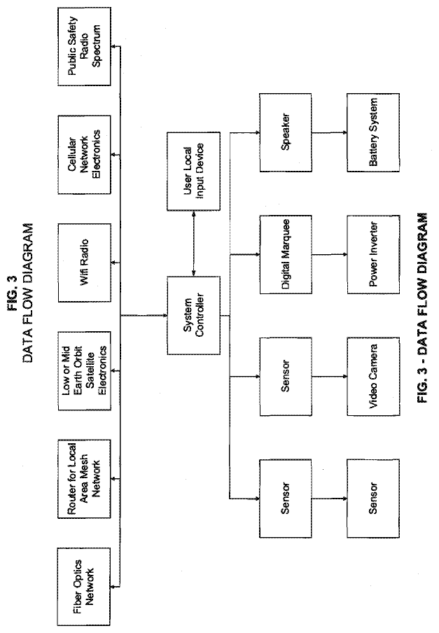

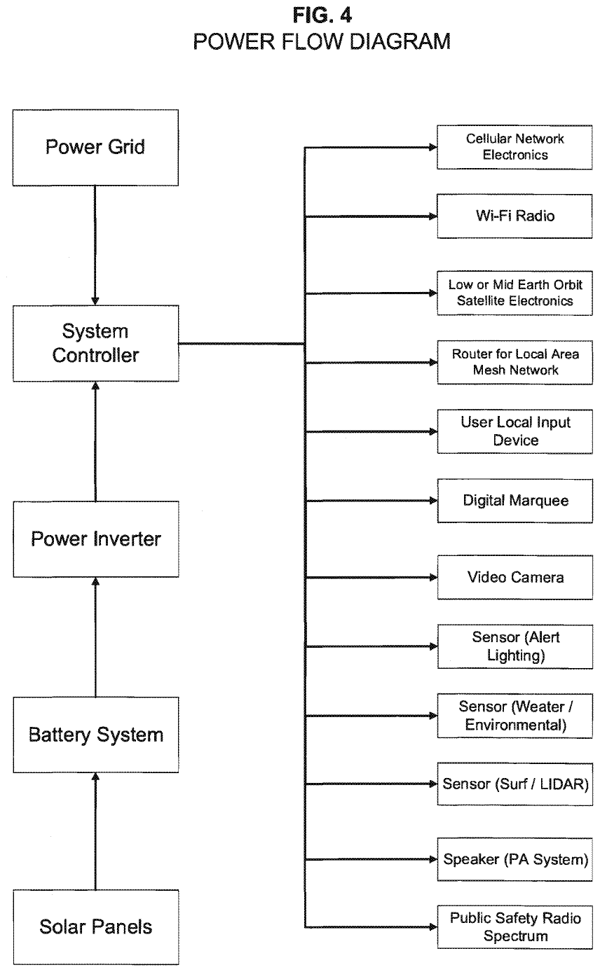

Referring to FIGS. 3 and 4, the system controller is operatively configured to receive user generated local operational input through one or more input interfaces, which may include, without limitation, a keypad, touchscreen, mechanical switch assembly, microphone array for voice input, or any combination thereof. The system controller is electrically and/or communicatively coupled to a plurality of environmental and system state sensors, and at least one video imaging device, such as a digital video camera, to acquire situational data and provide system feedback. The controller is further operably coupled to one or more output devices, including a digital marquee display and an audio speaker for presenting visual and audible output, respectively. The system controller is further configured to transmit and receive data through multiple communication modalities, including, but not limited to: (i) a fiber optic communication link; (ii) a router facilitated local area network (LAN) or mesh network; (iii) satellite communication via low Earth orbit (LEO) or mid Earth orbit (MEO) satellite constellations; (iv) WiFi compliant wireless networks; (v) cellular telecommunication networks (e.g., LTE, 5G); and/or (vi) public safety broadband and narrowband radio frequency spectrums (e.g., FirstNet, P25, TETRA). This multimodal communication architecture enables redundant and adaptive data exchange between the system controller and external systems or remote operators under a wide range of operational scenarios.

What is claimed is:

1. A multipurpose communications device comprising:
a support pole having a proximal end constructed and arranged for anchoring to a coastal beach front and a distal end vertically disposed above the breach front;
a telecommunication module coupled to said support pole and configured to provide wireless communication coverage, said telecommunication module including a communication interface configured to support the operation of multiple public and private, licensed and/or unlicensed wireless communication systems from different carriers and/or government entities, and an ISP satellite antenna to interface with low or mid earth orbit satellites;
a surf condition monitoring system integrated with said telecommunication module comprising: a wave height camera, a wind speed and direction sensor, a barometric pressure sensor, a receiver configured to receive sensory data transmitted from offshore sensors;
an alert lighting system coupled to said telecommunication module and configured to visually communicate hazard warnings and illuminate the surrounding area;
a digital signage display configured to display public safety messages;
a surveillance camera mounted to the pole and coupled to said telecommunication module;
a digital marquee configured to display public safety messages;
a system controller configured to operate and control the sensors, lighting system, camera, and signage remotely and in real time;
a power management system for supplying electrical power to the telecommunication module and the surf condition monitoring system;
wherein said communications device serves as a communications tower for a system to transmit and receive public and private network communications.

2. The multipurpose communications device of claim 1, including a radar or LIDAR based wave height sensor coupled to the said surf condition monitoring system.

3. The multipurpose communications device of claim 1, including a water temperature sensor positioned in a wireless communication with a remote buoy system.

4. The multipurpose communications device of claim 1, wherein said camera is further defined as a high definition video camera configured to pan, tilt, and rotate to monitor surf conditions and surrounding areas.

5. The multipurpose communications device of claim 1, wherein a communications interface is configured to send and receive data between the system controller and a remote management system to enable centralized control and aggregation of data.

6. The multipurpose communications device of claim 1, wherein the system controller is configured to receive commands and send data over a wireless network, including cellular, WiFi, public safety radio networks, mesh, or satellite networks.

7. The multipurpose communications device of claim 1, wherein the alert lighting system comprises color coded LED lights configured to indicate surf hazard levels.

8. The multipurpose communications device of claim 1, wherein the high definition video camera includes automated image recognition software configured to detect distressed swimmers or dangerous marine life.

9. The multipurpose communications device of claim 1, wherein the power management system including a connection to an external power grid.

10. The multipurpose communications device of claim 1, wherein the power management system including a solar power generation system mounted to or adjacent to the pole.

11. The multipurpose communications device of claim 1, wherein the power management system including a DC/AC inverter configured to convert solar generated power for use by AC powered components.

12. The multipurpose communications device of claim 1, wherein the power management system including a battery backup system configured to maintain operation of the pole during power outages.

13. The multipurpose communications device of claim 1, wherein the digital signage display comprises a daylight readable
LED or LCD panel configured to receive content updates from the system controller.

14. The multipurpose communications device of claim 1, wherein the structure is made of a material selected from the group consisting of basalt, fiberglass, aluminum, stainless steel, and composite materials, and is constructed and arranged to withstand saltwater corrosion and extreme weather.

15. The multipurpose communications device of claim 1, wherein the system controller is programmable to activate or deactivate any installed device based on time of day, environmental conditions, or remote input.

16. The multipurpose communications device of claim 1, wherein the communications interface is further configured to support public and private, licensed and unlicensed wireless communication systems used by different carriers and government agencies.

17. The multipurpose communications device of claim 1, wherein the system is adapted for use in environments beyond coastal areas, including crosswalks, traffic control points, school zones, and emergency warning networks.

18. The multipurpose communications device of claim 1, wherein the power management system includes a battery backup system.

19. The multipurpose communications device of claim 1, further comprising one or more user accessible charging outlets integrated into the base of the pole and managed by the power management system.
